(19) United States
(12) Patent Application Publication
(10) Pub. No.: US 2003/0093164 A1
(43) Pub. Date: May 15, 2003

(54) System for providing communication between a GUI and metrology control software

(76) Inventors: Martin Ebert, Fremont, CA (US); Ilya Chizhov, Oakland, CA (US); Carl Zaiser, Mountain View, CA (US)

Correspondence Address: STALLMAN & POLLOCK LLP, Suite 290, 121 Spear Street, San Francisco, CA, 94105, US

(21) Appl. No.: 10/144,431

(22) Filed: May 13, 2002

Related U.S. Application Data
(60) Provisional application No. 60/336,027, filed on Nov. 2, 2001.

(51) Int. Cl. G05B 15/00

(52) U.S. Cl. 700/83; 700/2

(57) ABSTRACT

A system for communication between the software components of an optical metrology system is provided. For this system, an optical metrology tool is configured to have a graphical user interface (GUI) process and a control software process. The GUI process is responsible for user interaction. The control software controls the operation of the optical metrology tool (e.g., data acquisition, robotic wafer handling, etc.). The GUI and control software processes communicate using two named pipes. The first, or inbound pipe is used by the GUI process to send commands to the control software process. The second, or outbound pipe is used by the control software process to send result messages to the GUI process. This decouples the GUI and control software processes. This facilitates the use of GUI development environments and allows the GUI process and control software process to be hosted on separate computer systems in networked environments.

### PRIORITY CLAIM

The present application claims priority to U.S. Provisional Patent Application Serial No. 60/336,027, filed Nov. 2, 2001, which is incorporated herein by reference.

### TECHNICAL FIELD

The subject invention relates to software for controlling the use of optical metrology tools for inspection and analysis of semiconductor wafers. In particular, an approach is disclosed that provides communication between the software components of an optical metrology tool.

### BACKGROUND OF THE INVENTION

Semiconductor manufacturers employ a wide range of systems to monitor the various processing steps used to fabricate semiconductor devices. Optical metrology systems are particularly desirable since they are non-contact, non-destructive and can measure very small spots on the wafer surface. Optical metrology devices include reflectometers and ellipsometers that are useful for evaluating thin film parameters as well as small periodic structures on a sample. Many of the commercial tools now available combine multiple technologies on a single platform. Examples of such systems can be found in U.S. Pat. Nos. 6,278,519 and 5,608,526 both incorporated herein by reference.

Optical metrology tools tend to be highly complex. To cope with this complexity, most metrology tools are governed by sophisticated control software. The control software is responsible for a range of tasks including data acquisition (collecting measurements from many different detectors), digital and analog input and output, autofocus control, movement of optical elements for different measurements, robotic wafer handling and a range of other tasks. In addition, control software is used for testing and verification of subsystem components, system integration, calibration, field installation and service procedures.

Optical metrology tools also have to interact with human operators. To do this, most metrology tool vendors provide a graphical user interface (GUI). The GUI allows operators to pass instructions to the tool, display camera images and measurement parameters, receive data from the tool to be analyzed and communicate with a host computer.

In the past, GUIs tended to be difficult to design and implement. Their construction required specialized knowledge of graphics as well as interactive constructs such as menuing systems and mouse inputs. Finding engineers having this specialized knowledge as well as the required understanding of the underlying optical metrology tools and control software could be a difficult task at best.

This concern has been largely alleviated by the creation of software development tools specifically targeted at the creation of GUIs. These tools, such as LabWindows/CVI by National Instruments allow a software developer to create GUIs using high level commands and visual interfaces. Use of such development software packages permits designers to create attractive, functional GUIs in less time. This is especially attractive because it allows engineers already familiar with the underlying metrology tool and control software to develop an associated GUI without acquiring the specialized knowledge formerly associated with GUI construction.

Unfortunately, there are still obstacles even when a GUI development tool is used. One of these is the need to provide an efficient interface between the GUI produced by the development tool and the metrology tool and control software. One approach is to use a system where the GUI and control software communicate by writing information to shared files. Each would also be configured to look for new information in the shared files. While this approach can work, it has drawbacks. For example, if the GUI and control software are continuously writing and checking for new files, there can be conflicts when one program calls up a file before the other program has finished writing to the file. To ensure accurate results, systems that use this approach generally need to adopt some sort of exclusive access methodology, such as semaphores or spin-locks. These methodologies can be difficult to implement unless they are specifically supported by the underlying operating system.

Accordingly, it would be desirable to provide an improved system for communicating between the control software for a metrology tool and a GUI.

### SUMMARY OF THE INVENTION

An aspect of the present invention provides a system for communication between the software components of an optical metrology system. For this system, an optical metrology tool is configured to have a graphical user interface (GUI) process and a control software process. The GUI process is responsible for all aspects of user interaction. The control software is the code that controls the operation of the optical metrology tool such as data acquisition (collecting measurements from many different detectors), digital and analog input and output, autofocus control, movement of optical elements for different measurements, robotic wafer handling and a range of other tasks.

The GUI process and the control software process communicate using at least two named pipes. The first, or inbound pipe is used by the GUI process to send commands to the control software process. The second, or outbound pipe is used by the control software process to send result messages to the GUI process.

The GUI process is configured to include a series of callback functions, each invoked by a different type of interactive operation (such as mouse clicks, menu selections, etc.). Upon invocation, each callback function sends one or more commands through the inbound pipe to the control software process. The control software process receives each command and identifies one or more metrology tool operations that are required for completion of the command. The control software process causes the metrology tool to perform each required operation and collects any associated output. The control software then encodes the output in a response message and sends the response message through the outbound pipe to the invoked callback function. The callback function uses the response message to update displays, data structures or other aspects of the GUI process.

In this way, the present invention provides a flexible method for interfacing a GUI with the control software of an optical metrology system. The system facilitates the use of different GUIs including those generated by popular GUI development programs. The system also facilitates networked operation where the GUI process and control software process are hosted on different computer systems that communicate via network connections. This is particularly useful where the network is an Internet-like network and the GUI process is a web-based interface that executes within a browser program.

### BRIEF DESCRIPTION OF THE DRAWINGS

FIG. 1 is a block diagram of an optical metrology tool configured to use the communication method of the present invention.

FIG. 2 is a process flow diagram showing the interaction between a graphical user interface and metrology control software using the communication method of the present invention.

FIG. 3 is a block diagram showing networked deployment of the communication method of the present invention.

### DESCRIPTION OF THE PREFERRED EMBODIMENTS

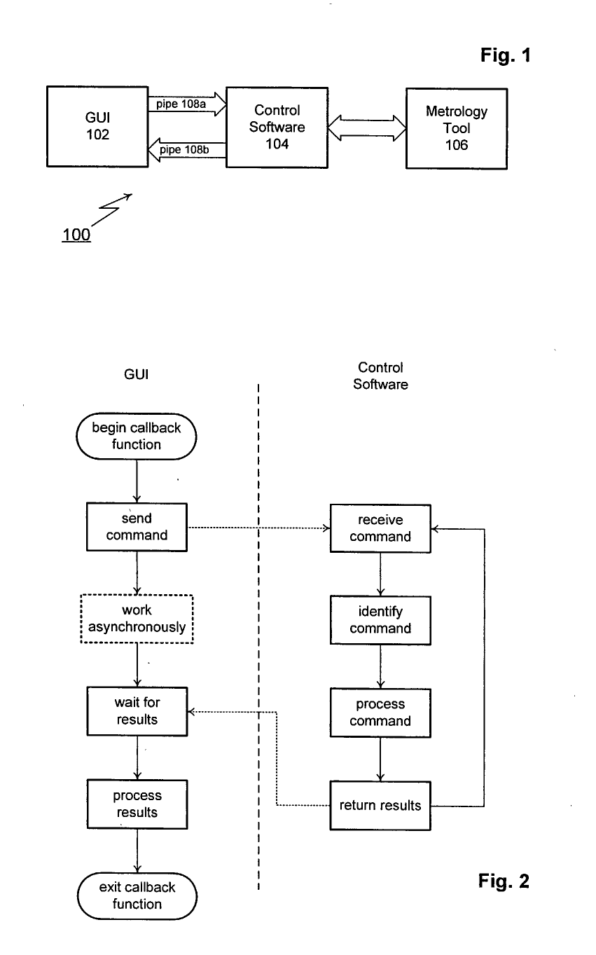

An aspect of the present invention provides a system for communication between the software components of an optical metrology system. FIG. 1 shows an optical metrology system 100 configured to use this method. As shown, optical metrology system 100 includes a graphical user interface (GUI) 102, control software 104 and an optical metrology tool 106. GUI 102 is intended to be representative of the wide range of GUI technologies that have been developed for use with computer programs. For this specific example, it may be assumed that GUI 102 has been created using a commercial GUI development environment such as LabWindows/CVI by National Instruments. It may also be assumed that GUI 102 is hosted within a Windows NT environment. It should be appreciated, however that both of these assumptions are exemplary in nature. GUI 102 may be constructed using any suitable technology and hosted in any suitable environment.

Optical metrology tool 106 is representative of the wide range of tools of this nature. For this particular example, optical metrology tool 106 may be assumed to be one of system s available from Therma-Wave Inc. Control software 104 is the code that controls the operation of optical metrology tool 106. As previously discussed, control software 104 performs a wide range of tasks including data acquisition (collecting measurements from many different detectors), digital and analog input and output, autofocus control, movement of optical elements for different measurements, robotic wafer handling and so on. In addition, control software 104 is used for testing and verification of subsystem components, system integration, calibration, field installation and service procedures. For this example, control software is hosted within the same runtime environment as GUI 102 (e.g., Windows NT).

GUI 102 and control software 104 communicate via pipes 108a and 108b. Pipes are file system objects that Windows NT programs (and programs within other environments such as UNIX) use for interprocess communications. Windows NT supports both anonymous and named pipes. Named pipes are particularly useful where interprocess communication is being performed between unrelated processes (i.e., processes that do not have a parent-child relationship). For this reason, GUI 102 and control software 104 communicate using named pipes. Each named pipe has an associated file system name of the form \\machine_name\pipe\pipe_name. One of the two processes (i.e., GUI 102 or control software 104) creates two unidirectional pipes 108 using names of this form. Both processes then attach to pipes 108. Once attached, pipe 108a acts as the inbound pipe for control software 104. GUI 102 uses inbound pipe 108a to send information and commands from control software 104. Pipe 108b acts as the outbound pipe for control software 104. Control software 104 uses outbound pipe 108b to send results and information to GUI 102.

FIG. 2 shows a process flow associated with a typical interaction between GUI 102 and control software 104. The process flow begins where a callback function is invoked. Callback functions are code sequences that are invoked by interactive and non-interactive events, such as mouse clicks or menu selections. GUI 102 will typically have a number of different callback functions, each associated with a different interactive event. After invocation, the callback function sends a command to control software 104 by writing the command on inbound pipe 108a. The command identifies a predefined action or procedure that control software 104 is configured to support. After it has finished writing the command to inbound pipe 108a, the callback function waits for a response from control software 104. During the waiting period, GUI 102 may optionally work asynchronously to perform any needed operations.

Control software 104 receives the command by reading inbound pipe 108a. After receipt, control software 104 determines the identity of the command it has received. This is required because control software 104 will generally support a range of different commands. With each received command, control software 104 must determined what it is expected to do.

After the command has been identified, control software performs whatever processing the command requires. Generally, this means that control software 104 causes optical metrology tool 106 to perform one or more operations such as collecting measurements from many different detectors or robotic wafer handling. Control software 104 collects the results of these operations (or any other processing) and writes a response message to the callback function on outbound pipe 108b.

The callback function receives the response message on outbound pipe 108b. This allows the callback function to discontinue waiting and process the results of the requested command. Generally this means that the callback function will perform steps such as displaying the results of the requested command or updating local data structures to reflect the results of the requested command. When it has completed processing the results of the requested command, the callback function returns.

In general, it should be appreciated that the process flow of FIG. 2 describes the processing of a single callback function. In many cases GUI 102 may be configured to have multiple simultaneously active callback functions. Control software 104 may also support multiple pending commands. Processing of these commands and callbacks may be asynchronous, meaning that GUI 102 and control software 104 do not have to operate in lock-step fashion.

As previously discussed, control software 104 is highly dependent on the specific type of optical metrology tool 106. In the case where optical metrology tool 106 is one of the systems available from Therma-Wave, Inc, control software 104 is known by the name IOPT. As shown in the following pseudo-code fragment, the control software executes the command loop portion of FIG. 2 (i.e., the loop that includes the receive command, identify command, process command and return results). Implementation of the command loop can be done using any high-level programming language. In an actual implementation, Therma-Wave's proprietary macro programming language has been used. A specific advantage is that control software 104 can be used in a range of different optical metrology tools, while the specific needs for the graphical user interface for any particular tool can be addressed by creating versions of GUI 102.

### EXAMPLE PSEUDOCODE RUN BY CONTROL SOFTWARE 104

LOOP

CHECK IF COMMAND IS DELIVERED THROUGH COMMAND PIPE
IF (COMMAND IS VALID)

EXECUTE COMMAND
IF (ERROR)

RESTART LOOP

ELSE

DELIVER RESULTS THROUGH RESULT PIPE

END IF

END IF

END LOOP

The preceding description has focused on an example where pipes 108 are used to perform interprocess communication between two processes (GUI 102 and control software 104) within the same Windows NT environment. It should be appreciated that the same methodology is applicable to a wide range of pipe-like communication channels and a wide range of different operating environments. For example, the \\machine_name\pipe\pipe_name naming format is designed to support communication between processes executing on different host computers. Use of this mechanism means that GUI 102 may be hosted remotely from control software 104. Other operating environments, such as Unix and Linux also support named-pipe operation. It is, therefore, possible to host one or both of GUI 102 and control software 104 on one of these different operating environments.

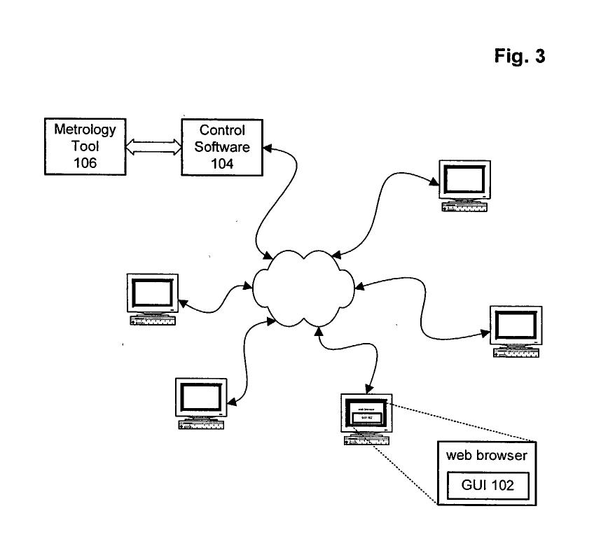

As shown in FIG. 3, an Internet-type network may also be used to interconnect GUI 102 and control software 104. Since named pipes are not supported in networks of this type, similar socket based connections are used. Sockets, like named-pipes are a form of communication channel that may be used to interconnect unrelated processes. GUI 102 is implemented as a web application using standard technologies such as HTML, Java or Javascript. This allows GUI 102 to be hosted by a web browser executing within any Internet connected end station. Control software 104 is hosted within a second Internet connected end station. Communications between GUI 102 and control software 104 are performed via the socket connections and follow the semantics previously described for the case of named pipes operating in local area network environments.

What is claimed is:

1. A method for controlling an optical metrology tool, the method comprising the following steps performed by a control software process for the optical metrology tool:
creating an inbound channel from a graphical user interface process and an outbound channel to the graphical user interface process;
receiving, a command from a graphical user interface process on the inbound channel;
identifying an operation of the optical metrology tool required for execution of the command;
causing the optical metrology tool to perform the identified operation;
formulating a response message corresponding to the output generated by the optical metrology tool when performing the identified operation; and
sending the response message to the graphical user interface process on the outbound channel.

2. A method as recited in claim 1, wherein the inbound channel and outbound channel are Windows NT named pipes.

3. A method as recited in claim 1, wherein the graphical user interface process and the control software process are hosted within different computer systems.

4. A method as recited in claim 1, wherein the graphical user interface process and the control software process communicate via an Internet-like network.

5. A method for controlling an optical metrology tool, the method comprising the following steps performed by a graphical user interface process:
attaching to inbound and outbound channels associated with control software process for the optical metrology tool;
invoking a callback function to handle an interactive command;
sending a command through the inbound channel, the command identifying an operation of the optical metrology tool;
receiving a response message through the outbound channel, the response message corresponding to the output generated by the optical metrology tool when performing the identified operation; and
updating the graphical user interface process to reflect the content of the response message.

6. A method as recited in claim 5, wherein the inbound pipe and outbound pipe are Windows NT named pipes.

7. A method as recited in claim 5, wherein the graphical user interface process and the control software process are hosted within different computer systems.

8. A method as recited in claim 5, wherein the graphical user interface process and the control software process communicate via an Internet-like network.
